(19) United States
(12) Patent Application Publication
(10) Pub. No.: US 2024/0055163 A1
(43) Pub. Date: Feb. 15, 2024

(54) SINTERED R-FE-B PERMANENT MAGNET, PREPARATION METHOD AND USE THEREOF

(71) Applicants: NANTONG ZHENGHAI MAGNET CO., LTD., Rugao City (CN); YANTAI ZHENGHAI MAGNETIC MATERIAL CO., LTD., Yantai (CN)

(72) Inventors: Wei LI, Rugao City (CN); Zhongxin AN, Rugao City (CN); Yunting SU, Rugao City (CN); Lei LIU, Rugao City (CN); Yunying JIANG, Rugao City (CN); Zhongyu LIU, Rugao City (CN)

(21) Appl. No.: 18/448,487

(22) Filed: Aug. 11, 2023

(30) Foreign Application Priority Data
Aug. 11, 2022 (CN) 202210962847.2

(51) Int. Cl. H01F 1/057

(52) U.S. Cl. CPC H01F 1/0577

(57) ABSTRACT

A sintered R—Fe—B permanent magnet has at least a grain boundary and composite main phase grains. The grain boundary has an RH-rich phase distributed in the form of an agglomerate within the grain boundary between the composite main phase grains, preferably at the intersection of any adjacent three or more composite main phase grains. The RH-rich phase is continuously distributed along the grain boundary in the form of a thin-layer stripe. The composite main phase grain has a core-shell structure, which includes a core structure having an R-T-B type phase structure and a shell structure on the outer layer of the core structure. The core structure contains Ce-rich main phase grains and Ce-poor main phase grains.

### CROSS-REFERENCE TO RELATED APPLICATION

The present application claims priority to the prior application with the patent application No. CN 202210962847.2 entitled “SINTERED R-FE-B PERMANENT MAGNET, PREPARATION METHOD AND USE THEREOF” and filed with the China National Intellectual Property Administration on Aug. 11, 2022, the content of which is incorporated herein by reference in its entirety.

### TECHNICAL FIELD

The present disclosure belongs to the technical field of the preparation of rare earth permanent magnet materials, and particularly relates to a sintered R—Fe—B permanent magnet with grain boundary diffusion, a preparation method and an use thereof.

### BACKGROUND

Sintered neodymium-iron-boron, as the third generation rare earth permanent magnet material, mainly consists of elements such as rare earth PrNd, iron, boron, and the like, and is widely applied to the fields of various rare earth permanent magnet motors, intelligent consumer electronic products, medical devices, and the like due to its excellent magnetic properties and high cost performance. With the rapid development of low-carbon, environment-friendly, economical, and high-new technologies, the demand for sintered neodymium-iron-boron magnets is increasing day by day, which greatly drives the consumption of rare earth PrNd resources, such that the price of PrNd is gradually increased. La and Ce, as rare earth elements with chemical properties similar to those of PrNd and the most abundant reserves, have limited use in the field of rare earth permanent magnet materials due to their relatively low intrinsic magnetic properties. At present, how to increase the usage of La and Ce elements to reduce costs without affecting the magnetic properties has become one of the research subjects for saving rare earths.

In the prior art, there are mainly the following approaches to add La and Ce into magnets: the first approach is to add in an alloying way, that is, to add metal La and Ce raw materials during the smelting process; the second approach is to add by a double alloy method, that is, to prepare (R, LaCe)—Fe—B and R—Fe—B alloy slices (R is selected from one or more of Nd, Pr, Dy, Tb, Ho, and Gd), respectively, by smelting, and then press and sinter the alloy slices described above after mixing them in a certain ratio; the third approach is to attach a compound or alloy of La and Ce on the surface of the magnet and perform an appropriate heat treatment process to diffuse La and Ce into the interior of the magnet. In the methods described above, the addition in an alloying way can cause La and Ce to enter main phase grains, such that the properties of the main phase grains, such as saturation magnetic polarization intensity, Curie temperature, magnetocrystalline anisotropy field, and the like, can be reduced, thereby reducing the initial properties of the magnet, and further limiting the application development of the magnet. However, adding La and Ce into the interior of the magnet by diffusion has technical defects, such as the complicated process, insufficient addition amounts of La and Ce, difficulty in increasing the coercivity of the magnet, and the like, so the cost performance is low, which is not conducive to the application development of the magnet. The addition of the double alloy can prevent La and Ce from entering the main phase grains to some extent, and thus, the method has gradually become a mainstream preparation process of neodymium-iron-boron magnets containing La and Ce.

However, in order to achieve the preparation of high-performance neodymium-iron-boron magnets containing La and Ce and to compensate for the reduction of magnetic properties caused by the addition of La and Ce, a certain amount of heavy rare earth elements such as Dy and Tb are usually added to improve the magnetic properties of the magnets when the La- and Ce-rich magnets are prepared, and the heavy rare earth grain boundary diffusion technology is the most effective and easily-achieved method at present. Therefore, it has been studied that the NdCeFeB double alloy and the grain boundary diffusion technology are superimposed to prepare a magnet with a high coercivity, but the properties of the obtained magnet are not as expected, which is mainly attributed to the fact that the grain boundary phase component and the grain boundary structure of the base magnet for diffusion in the heavy rare earth grain boundary diffusion technology play a decisive role in permeation of the heavy rare earth and flow dispersion of the heavy rare earth in the interior of the magnet.

In the neodymium-cerium-iron-boron magnet prepared by the double alloy method, due to the difference in the component of main and auxiliary phases, there is a significant concentration difference of the constituent elements, which seriously affects the permeation of heavy rare earth elements into the interior of the magnet, and finally, the coercivity of the magnet is not significantly improved. Due to the heterogeneity of the distribution of rare earth elements in two main phases, the grain boundary diffusion of the heavy rare earth involves a plurality of situations. In one aspect, Nd in the main phase of Nd2Fe14B is replaced by diffusion, and in another aspect, Ce in the main phase of Ce2Fe14B is replaced by diffusion. The two processes compete with each other, and the replaced Nd or Ce will further undergo a replacement process by diffusion, resulting in the replacement of the heavy rare earth into the main phase, such that the utilization rate of the heavy rare earth is not high, and the coercivity of the magnet after diffusion is poor.

### SUMMARY

In order to solve the above technical problems, the present disclosure provides an R—Fe—B permanent magnet with a high coercivity, a preparation method and use thereof.

The present disclosure provides an R—Fe—B permanent magnet, which comprises at least a grain boundary and composite main phase grains,

wherein the grain boundary comprises an RH-rich phase distributed in the form of an agglomerate within the grain boundary between the composite main phase grains, preferably at the intersection of any adjacent three or more composite main phase grains; the RH-rich phase can also be continuously distributed along the grain boundary in the form of a thin-layer stripe;

RH in the grain boundary has a content greater than that of the RH in the main phase grains, and the RH is at least one selected from heavy rare earth metals such as Dy, Tb, Ho, and the like;

the composite main phase grain has a core-shell structure, wherein the core-shell structure comprises a core structure having an R-T-B type phase structure and a shell structure on the outer layer of the core structure;

the core structure comprises Ce-rich main phase grains and Ce-poor main phase grains; Ce in the Ce-rich main phase grains has a content of 1-15 wt %; Ce in the Ce-poor main phase grains has a content of 0-1 wt %.

According to an embodiment of the present disclosure, the RH in the grain boundary preferably has a content greater than that of the RH in the shell structure.

According to an embodiment of the present disclosure, the permanent magnet comprises RL, the RL is at least one selected from light rare earth metals such as Pr and Nd.

According to an embodiment of the present disclosure, RL in the shell structure has a content greater than or equal to that of the RL in the core structure.

According to an embodiment of the present disclosure, the permanent magnet has a structure as shown in FIG. 1, and the permanent magnet comprises at least: a grain boundary and composite main phase grains, wherein the composite main phase grain has a core-shell structure, wherein a core structure comprises Ce-rich main phase grains and Ce-poor main phase grains, and the outer layer of the core structure is provided with a shell structure; RL in the shell structure has a content greater than or equal to that of the RL in the core structure, and RH in the grain boundary has a content greater than that of the RH in the main phase grains.

According to an embodiment of the present disclosure, the R-T-B type phase structure comprises at least the following components:
R, with a weight percentage of 28%≤R≤35%, wherein the R is selected from neodymium (Nd) and cerium (Ce), and optionally comprises or does not comprise at least one selected from scandium (Sc), yttrium (Y), lanthanum (La), cerium (Ce), praseodymium (Pr), samarium (Sm), europium (Eu), gadolinium (Gd), terbium (Tb), dysprosium (Dy), holmium (Ho), erbium (Er), thulium (Tm), ytterbium (Yb), and lutetium (Lu);
B, with a weight percentage of 0.8%≤B≤1.2%;
M, with a weight percentage of 0≤M≤5%, wherein the M is at least one selected from aluminum (Al), titanium (Ti), copper (Cu), gallium (Ga), zirconium (Zr), and niobium (Nb); and the balance of T, wherein the T is consists of iron (Fe) and optionally presented cobalt (Co).

According to an embodiment of the present disclosure, the permanent magnet is prepared by mixing a powder of a low-Ce master alloy and a powder of a high-Ce auxiliary alloy, press molding, sintering treatment, and then performing composite diffusion treatment.

Preferably, Ce in the low-Ce master alloy has a content not greater than 1 wt %, preferably 0-1 wt %.

Preferably, Ce in the high-Ce auxiliary alloy has a content greater than 1 wt % and not greater than 15 wt %.

According to an embodiment of the present disclosure, the permanent magnet, from the surface to the core, has phase structures of the grain boundary and the composite main phase grains described above. The core of the permanent magnet in the present disclosure refers to a position at least 500 μm away from the surface of the permanent magnet.

According to an embodiment of the present disclosure, the content of Ce in the grain boundary phase is not particularly limited.

The present disclosure further provides a preparation method of the permanent magnet described above, which comprises mixing a powder of a low-Ce master alloy and a powder of a high-Ce auxiliary alloy, press molding, and sintering treatment to obtain a blank, and performing composite diffusion treatment on the blank to obtain the permanent magnet.

Preferably, Ce in the low-Ce master alloy has a content not greater than 1 wt %, preferably 0-1 wt %, such as 0.1 wt %, 0.2 wt %, 0.3 wt %, 0.4 wt %, 0.5 wt %, 0.6 wt %, 0.7 wt %, 0.8 wt %, 0.9 wt %, or 1 wt %.

Preferably, Ce in the high-Ce auxiliary alloy has a content greater than 1 wt % and not greater than 15 wt %, such as 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %.

According to an embodiment of the present disclosure, the powder of the low-Ce master alloy and the powder of the high-Ce auxiliary alloy may be prepared by methods known in the art, such as hydrogen decrepitation, dehydrogenation, and milling of alloy slices. The hydrogen decrepitation, dehydrogenation, and milling may be performed by methods known in the art.

As an example, the low-Ce master alloy is prepared into a master alloy slice, which is then subjected to hydrogen decrepitation, dehydrogenation, and milling to obtain a powder of the low-Ce master alloy.

As an example, the high-Ce auxiliary alloy is prepared into an auxiliary alloy slice, which is then subjected to hydrogen decrepitation, dehydrogenation, and milling to obtain a powder of the high-Ce auxiliary alloy.

According to an embodiment of the present disclosure, the powder of the low-Ce master alloy and the powder of the high-Ce auxiliary alloy are in a mass ratio of (1-50):1, such as 1:1, 5:1, 10:1, or 20:1.

According to an embodiment of the present disclosure, the press molding comprises mixing the powder of the low-Ce master alloy and the powder of the high-Ce auxiliary alloy, and then press molding under the action of a magnetic field to obtain a green body.

Preferably, the magnetic field may be a magnetic field known in the art, for example, a magnetic field with a magnetic field intensity of 2 T.

According to an embodiment of the present disclosure, the press molding may be performed using devices known in the art, for example, in the cavity of a press and grinding tool.

According to an embodiment of the present disclosure, after press molding, cold isostatic pressing treatment can also be performed to further improve the density of the blank.

According to an embodiment of the present disclosure, the sintering treatment comprises heating the green body to 1000-1100° C. under a vacuum atmosphere to obtain a blank.

According to an embodiment of the present disclosure, the composite diffusion treatment comprises: arranging a diffusion material on the surface of the blank, and performing heat treatment.

According to an embodiment of the present disclosure, the diffusion material may be arranged on the surface of the blank by methods known in the art, and the present disclosure is not particularly limited.

According to an embodiment of the present disclosure, the surface of the blank is uniformly coated with a slurry containing the diffusion material.

According to an embodiment of the present disclosure, the diffusion material comprises RH and RL optionally with or without the addition of an M powder.

Preferably, the RH is at least one selected from heavy rare earth metals such as Dy, Tb, Ho, and the like.

Preferably, the RL is at least one selected from light rare earth metals such as Pr, Nd, and the like.

Preferably, the M powder is selected from Ga and/or Cu.

According to an embodiment of the present disclosure, the diffusion material comprises the following components: RH with a content of 20-70 wt %, RL with a content of 20-70 wt %, and an M powder with a content of 0-10 wt %.

Preferably, the RH, the RL, and the M powder in the diffusion material are in a mass ratio of (1-10):(1-5):(0-2), such as 8:3:0, 4:4:0, or 4:3.5:0.5.

According to an embodiment of the present disclosure, the RH and the RL are provided by powders of the RH and the RL, respectively.

Preferably, the powder of the RH is at least one selected from a single metal of the RH, an alloy of the RH, an oxide of the RH, a fluoride of the RH, a hydride of the RH, and an oxyfluoride of the RH. As an example, the powder of the RH is at least one selected from a single metal of Dy, an alloy of Dy, an oxide of Dy, a fluoride of Dy, a hydride of Dy, and an oxyfluoride of Dy. As an example, the powder of the RH is at least one selected from a single metal of Tb, an alloy of Tb, an oxide of Tb, a fluoride of Tb, a hydride of Tb, and an oxyfluoride of Tb. As an example, the powder of the RH is at least one selected from a single metal of Ho, an alloy of Ho, an oxide of Ho, a fluoride of Ho, a hydride of Ho, and an oxyfluoride of Ho.

Preferably, the powder of the RL is at least one selected from a single metal of the RL, an alloy of the RL, an oxide of the RL, a fluoride of the RL, a hydride of the RL, and an oxyfluoride of the RL. As an example, the powder of the RL is at least one selected from a single metal of Pr, an alloy of Pr, an oxide of Pr, a fluoride of Pr, a hydride of Pr, and an oxyfluoride of Pr. As an example, the powder of the RL is at least one selected from a single metal of Nd, an alloy of Nd, an oxide of Nd, a fluoride of Nd, a hydride of Nd, and an oxyfluoride of Nd.

According to an embodiment of the present disclosure, a diffusion adjuvant and/or a solvent may also be added to the diffusion material, wherein the diffusion adjuvant and the solvent are selected from materials known in the art, for example, the diffusion adjuvant is 4-hexylresorcinol and the solvent is ethanol.

Preferably, the amount of the diffusion adjuvant and/or the solvent used in the present disclosure is not particularly limited as long as the diffusion of the diffusion material described above can be achieved.

As an example, the RH, the diffusion adjuvant, and the solvent in the diffusion material are in a mass ratio of (1-5):(0-3):(0-3), such as 4:2:1.

In the present disclosure, due to the significant difference in the component of the composite main phase grains and the interior of the single composite main phase grain, the chemical components and the heterogeneity of the distribution cause the interior of the permanent magnet to have short-range strong exchange effect and long-range magnetostatic coupling effect, thereby effectively improving the nucleation fields of reversal magnetization domain nuclei of the permanent magnet, inhibiting the nucleation of the reversal magnetization domain nuclei, hindering the expansion of the reversal magnetization domain nuclei, and further significantly improving the coercivity of the permanent magnet.

However, when a permanent magnet is prepared by a single alloy process using Ce or Nd and a composite diffusion process, or a permanent magnet is prepared by a double alloy process using Nd and Ce and an RH diffusion process, the same performance level cannot be achieved, because the components of main phase grains are substantially equivalent and are homogeneous, and a long-range magnetostatic coupling effect cannot be formed, such that the Hcj performance equivalent to that of the present disclosure cannot be obtained under the same components and process conditions. The present disclosure further provides use of the permanent magnet described above, such as in a motor.

### Advantageous Effects

1. The permanent magnet prepared in the present disclosure comprises two different composite main phase grains, and the long-range magnetostatic coupling effect between the grains and the short-range strong exchange effect inside the single composite main phase grain enable the permanent magnet to have a high coercivity magnetic property.

2. By means of a composite diffusion treatment, the present disclosure can ensure that heavy rare earth elements arranged on the surface of the permanent magnet diffuse more deeply and have better diffusion effect, and the core of the permanent magnet far away from the surface (that is, a position 500 μm away from the surface) also has the composite phase structural characteristics described above, such that the organization of the whole permanent magnet presents distribution uniformity, thereby effectively improving the coercivity and the squareness of the permanent magnet, and significantly improving the capacity of resisting demagnetization of the permanent magnet at a high temperature.

3. In addition, by means of composite diffusion sources, the present disclosure effectively reduces the melting point of a grain boundary phase, increases the diffusion channel of the heavy rare earth elements, improves the diffusion distance of the heavy rare earth elements in the permanent magnet, ensures that each microscopic region in the permanent magnet can form composite main phase grains, and improves the distribution uniformity of the organization structure, thereby further improving the Hcj and the squareness of the permanent magnet.

### BRIEF DESCRIPTION OF THE DRAWINGS

FIG. 1 is a schematic diagram showing the characteristics of a main phase and a grain boundary phase of the surface layer of a permanent magnet in Example 1-1.

FIG. 2 is a scanning electron microscopic back scattering image of the core (50 μm away from the surface of the permanent magnet) of the permanent magnet in Example 1-1.

FIGS. 3A and 3B are EPMA images of Dy element and Pr element on a cross section of the core (50 μm away from the surface of the permanent magnet) of the permanent magnet in Example 1-1 (FIG. 3A is a distribution image of the Dy element, and FIG. 3B is a distribution image of the Pr element).

FIG. 4 is an EPMA image in which the content of Ce element is linearly scanned through the main phase grains on the cross section of the core (50 μm away from the surface of the permanent magnet) of the permanent magnet in Example 1-1.

FIGS. 5A and 5B are a scanning electron microscopic back scattering image of the core (50 μm away from the surface of the permanent magnet) of the permanent magnet (FIG. 5A) and an EMPA image of the Dy element on the cross section of the core (FIG. 5B) in Comparative Example 1-1.

### DETAILED DESCRIPTION

The technical solutions of the present disclosure will be further illustrated in detail with reference to the following specific examples. It will be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the raw materials and reagents used in the following examples are all commercially available products or can be prepared using known methods.

### Example 1-1

The preparation method of an R—Fe—B permanent magnet was as follows:
(1) Preparation of alloy slices: according to components of a main phase alloy and an auxiliary phase alloy as shown in Table 1, raw materials were weighed out, respectively, and main phase alloy slices and auxiliary phase alloy slices were prepared in the following way: smelting in a vacuum induction smelting furnace under Ar atmosphere, and casting the molten liquid onto a quenching roller with a rotating speed of 32 rpm at a liquid casting temperature of 1400° C. to obtain the main phase alloy slices with an average thickness of 0.25 mm and the auxiliary phase alloy slices with an average thickness of 0.30 mm;
(2) Preparation of alloy powders: the main phase alloy slices and the auxiliary phase alloy slices were prepared into a main phase alloy powder and an auxiliary phase alloy powder with average grain diameters of 3.0 μm and 2.8 μm through hydrogen decrepitation, dehydrogenation, and air flow milling, respectively.

The main phase alloy powder and the auxiliary phase alloy powder were mixed in a mass ratio of 3:1 under N₂ atmosphere, an anti-oxidation lubricant accounting for 0.05 wt % was added, and the mixture was stirred and mixed uniformly;
(3) Press molding: the mixed powder was filled into a die cavity of a die of a pressing device under N₂ atmosphere, subjected to oriented-press molding with an orientation magnetic field intensity of 3 T, and then subjected to an isostatic pressing treatment in an isostatic pressing machine under a pressure of 180 MPa to obtain a pressed compact;
(4) Sintering treatment: the pressed compact in step (3) was placed in a vacuum sintering furnace, heated to 300-400° C. at a heating rate of 3° C./min, and heated to 670° C. at a heating rate of 5° C./min. The temperature was kept at 670° C. for 70 min, and the pressed compact was heated to 1040° C. at a heating rate of 8° C./min and subjected to sintering treatment for 5 h. The pressed compact was then subjected to a first-stage aging treatment at 900° C. for 4 h and a second-stage aging treatment at 530° C. for 3 h to obtain a sintered blank;
the blank described above was processed into a sheet with a size of 40×25 mm, wherein the thickness in an orientation direction was 5 mm;
(5) Diffusion treatment: ingredients were mixed according to a mass ratio of Dy single metal, Pr single metal, 4-hexylresorcinol, and ethanol of 4:4:2:1. Then the ingredients were mechanically stirred and mixed for 2 h to obtain a diffusion slurry containing Dy and Pr; the surface of the sheet obtained in step (4) was uniformly coated with the diffusion slurry described above with a coating amount of 1% of the mass of the base magnet, and the sheet was dried at 60° C. for 5 min to obtain a sheet coated with Dy and Pr metal diffusion sources. The sheet was subjected to vacuum permeation at 740° C. for 4 h, then the vacuum permeation at 930° C. for 6 h, and finally a vacuum aging treatment at 500° C. for 4.5 h to obtain an R—Fe—B permanent magnet M1 after Dy and Pr mixed diffusion treatment.

TABLE 1
Raw material table for Examples 1-1 to 1-4

| | PrNd | Ce | Tb | Co | Al | Ti | Cu | Ga | Zr | B |
|---|---|---|---|---|---|---|---|---|---|---|
| Main phase alloy | 30 | 0 | 1 | 1 | 0.5 | 0.2 | 0.1 | 0.4 | 0.2 | 1 |
| Auxiliary phase alloy | 17 | 15 | 0 | 1 | 0.2 | 0 | 0.3 | 0 | 0 | 0.98 |

### Example 1-2

The preparation method of the permanent magnet in this example was substantially the same as that in Example 1-1, except that Pr was replaced by Nd in the diffusion slurry in step (5).

### Example 1-3

The preparation method of the permanent magnet in this example was substantially the same as that in Example 1-1, except that the diffusion slurry in step (5) further comprised Cu, and the diffusion slurry was mixed according to a mass ratio of Dy single metal, Pr single metal, Cu metal, 4-hexylresorcinol, and ethanol of 4:3.5:0.5:2:1.

### Comparative Example 1-1

The preparation method of the permanent magnet in this comparative example was substantially the same as that in Example 1-1, except that the diffusion slurry in step (5) did not comprise Pr.

The test results of the magnetic properties of the sintered blank in Example 1-1 and the permanent magnets prepared in Examples 1-1 to 1-3 and Comparative Example 1-1 are shown in Table 2.

TABLE 2
Magnetic properties in Examples 1-1 to 1-3 and
Comparative Example 1-1

| | Diffusion | | | |
|---|---|---|---|---|
| | material | Hcj | Br | Squareness |
| Sintered blank | / | 1275 | 1.353 | 0.985 |
| Example 1-1 | Dy-Pr | 1795 | 1.334 | 0.971 |
| Example 1-2 | Dy-Nd | 1805 | 1.337 | 0.973 |
| Example 1-3 | Dy-Pr-Cu | 1810 | 1.332 | 0.977 |
| Comparative Example 1-1 | Dy | 1671 | 1.341 | 0.951 |

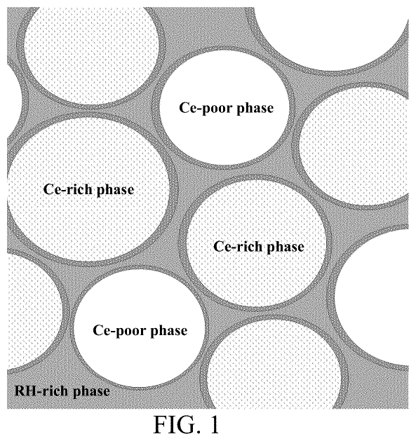

FIG. 1 is a schematic diagram showing the characteristics of a main phase and a grain boundary phase of the surface layer of the permanent magnet in Example 1-1.

FIG. 2 is a schematic diagram showing the characteristics of a main phase and a grain boundary phase of the core (500 μm away from the surface of permanent magnet) of the permanent magnet in Example 1-1.

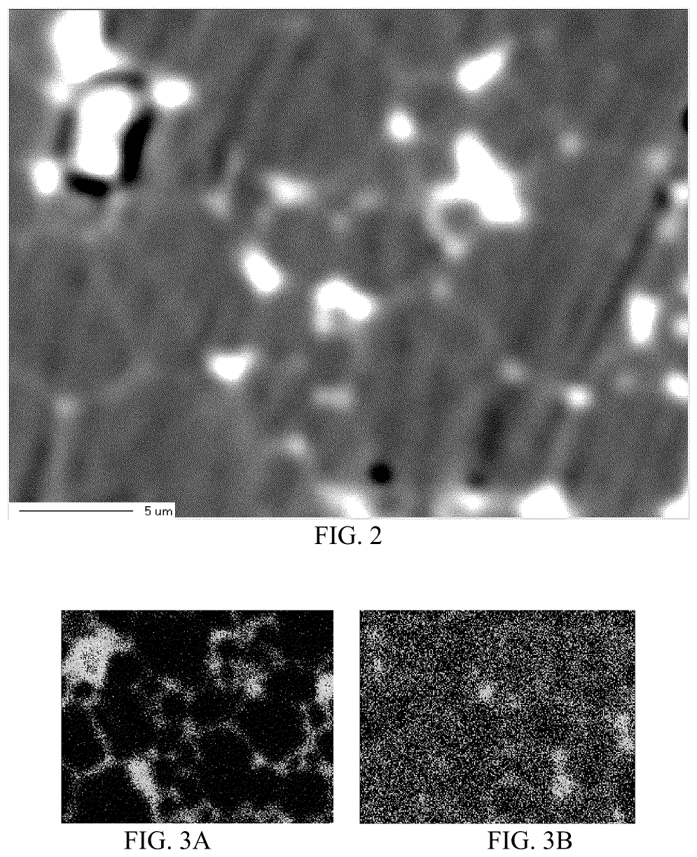

FIGS. 3A and 3B are EPMA images of Dy element and Pr element on a cross section of the core (50 μm away from the surface of the permanent magnet) of the permanent magnet in Example 1-1 (the left image is a distribution image of the Dy element, and the right image is a distribution image of the Pr element).

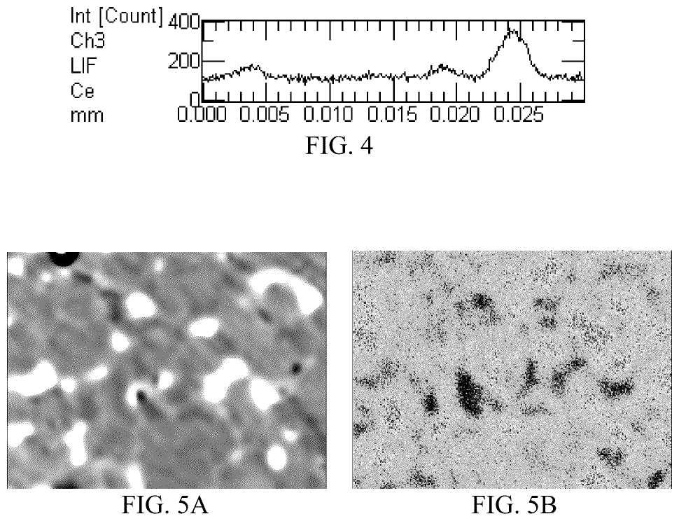

FIG. 4 is an EPMA image in which the content of Ce element is linearly scanned through the main phase grains on the cross section of the core (50 μm away from the surface of the permanent magnet) of the permanent magnet in Example 1-1.

As can be seen from FIGS. 1 to 4, the permanent magnet comprises at least a grain boundary and composite main phase grains, wherein the grain boundary comprises an RH-rich phase distributed in the form of an agglomerate within the grain boundary between the composite main phase grains, preferably at the intersection of any adjacent three or more composite main phase grains, and the RH-rich phase is continuously distributed along the grain boundary in the form of a thin-layer stripe.

As can be seen from FIGS. 2, 3A, and 3B, the RH-rich phase in the permanent magnet is a bright white region in the back scattering imaging mode of the scanning electron microscope, and is distributed between adjacent main phase grains or at the intersection of three or more main phase grains, and the content of the RH in the RH-rich phase is greater than that of the RH in the main phase grains.

As can be seen from FIGS. 2 and 4, the composite main phase grains include Ce-rich main phase grains and Ce-poor main phase grains, which are dark gray regions in the back scattering imaging mode of the scanning electron microscope; in the Ce-rich main phase grains, the content of Ce is 14.5 wt %; in the Ce-poor main phase grains, the content of Ce is 0.5 wt %.

As can be seen from FIGS. 2, 3A, and 3B, the composite main phase grain has a core-shell structure, wherein the shell structure is a light gray region in the back scattering imaging mode of the scanning electron microscope, which is enriched with RL elements, and the content of the RL in the shell structure is greater than or equal to that of the RL in the core structure.

Further, FIGS. 3A and 3B are a distribution image of the Dy element on the cross section of the core (50 μm away from the surface of the permanent magnet) of the permanent magnet in Example 1-1, and FIGS. 5A and 5B are a distribution image of the Dy element on the cross section of the core (50 μm away from the surface of the permanent magnet) of the permanent magnet in Comparative Example 1-1. As can be seen from FIGS. 3A, 3B, 5A, and 5B, the sintered blanks with the same component in Example 1-1 and Comparative Example 1-1 were used for composite diffusion treatment. As can be seen from the measurement results in FIGS. 3A, 3B, and 4, the change in the diffusion treatment method did not cause a change in the Dy content in the interior of the magnet along the diffusion direction, but the coercivity in the interior of the magnet was greatly improved. The inventors believed that the difference in the coercivity of the permanent magnets obtained by the two diffusion methods was not caused by the concentration gradient, but by the difference in microstructure. As can be seen by observing the cross section at the position 50 μm away from the surface of the permanent magnet, the Dy element in the sample of Example 1 formed more continuous enriched streaks along the grain boundary, whereas the Dy element in the sample of Comparative Example 1 was not enriched at the grain boundary but was replaced into the main phase by a diffusion replacement process. This is because when RL is contained in the diffusion material, it diffuses into the main phase more easily than RH, causing the main phase to form a core-shell structure. The content of the RL in the shell structure of the surface of the permanent magnet is relatively high, such that the RH in the diffusion material can be prevented from being replaced into the main phase structure, and thus the Dy element can diffuse along the grain boundary to the core of the permanent magnet. According to the above analysis, the RH element in the grain boundary phase of the permanent magnet prepared by the present disclosure can diffuse into the deeper position of the core away from the surface layer of the permanent magnet, indicating that the composite diffusion treatment effect of the present disclosure is good.

### Example 2-1

The preparation method of the permanent magnet in this example was substantially the same as that in Example 1-1, except that the raw materials were weighed out according to components of a main phase alloy and an auxiliary phase alloy as shown in Table 3, respectively.

TABLE 3
Raw material table for Examples 2-1 to 2-3 and Comparative Example 2-1

| | PrNd | Ce | Tb | Co | Al | Ti | Cu | Ga | Zr | B |
|---|---|---|---|---|---|---|---|---|---|---|
| Main phase alloy | 30 | 1 | 1 | 1 | 0.5 | 0.2 | 0.1 | 0.4 | 0.2 | 1 |
| Auxiliary phase alloy | 17 | 15 | 0 | 1 | 0.2 | 0 | 0.3 | 0.0 | 0 | 0.98 |

### Example 2-2

The preparation method of the permanent magnet in this example was substantially the same as that in Example 2-1, except that Pr was replaced by Nd in the diffusion slurry in step (5).

### Example 2-3

The preparation method of the permanent magnet in this example was substantially the same as that in Example 2-1, except that the diffusion slurry in step (5) further comprised Cu, and the diffusion slurry was mixed according to a mass ratio of Dy single metal, Pr single metal, Cu metal, 4-hexylresorcinol, and ethanol of 4:3.5:0.5:2:1.

### Comparative Example 2-1

The preparation method of the permanent magnet in this comparative example was substantially the same as that in Example 2-1, except that the diffusion slurry in step (5) did not comprise Pr. The test results of the magnetic properties of the sintered blank in Example 2-1 and the permanent magnets prepared in Examples 2-1 to 2-3 and Comparative Example 2-1 are shown in Table 4.

TABLE 4
Magnetic properties in Examples 2-1 to 2-3 and
Comparative Example 2-1

| | Diffusion | | | |
|---|---|---|---|---|
| | material | Hcj | Br | Squareness |
| Sintered blank | / | 1215 | 1.344 | 0.986 |
| Example 2-1 | Dy-Pr | 1720 | 1.315 | 0.970 |
| Example 2-2 | Dy-Nd | 1730 | 1.311 | 0.974 |
| Example 2-3 | Dy-Pr-Cu | 1732 | 1.313 | 0.978 |
| Comparative Example 2-1 | Dy | 1628 | 1.321 | 0.953 |

As can be seen from Tables 3 and 4, the Hcj of the permanent magnet increased significantly when the composite diffusion material comprised RH and RL.

### Comparative Example 3

The preparation method of the permanent magnet in this comparative example was substantially the same as that in Example 1-1, except that the raw materials were weighed out according to components of a main phase alloy and an auxiliary phase alloy as shown in Table 5, respectively.

TABLE 5
Raw material table for Comparative Example 3

| | PrNd | Ce | Tb | Co | Al | Ti | Cu | Ga | Zr | B |
|---|---|---|---|---|---|---|---|---|---|---|
| Main phase alloy | 30 | 1.5 | 1 | 1 | 0.5 | 0.2 | 0.1 | 0.4 | 0.2 | 1 |
| Auxiliary phase alloy | 17 | 15 | 0 | 1 | 0.2 | 0 | 0.3 | 0.0 | 0 | 0.98 |

The test results of the magnetic properties of the sintered blank and the permanent magnet prepared in Comparative Example 3 are shown in Table 6.

TABLE 6
Magnetic properties in Comparative Example 3

| | Diffusion | | | |
|---|---|---|---|---|
| | material | Hcj | Br | Squareness |
| Sintered blank | | 1201 | 1.339 | 0.985 |
| Comparative Example 1 | Dy-Pr | 1589 | 1.312 | 0.947 |

As can be seen by comparing Tables 2, 4, and 6, when Ce in the main phase alloy was 0-1% and the composite diffusion treatment was performed, the properties were significantly improved, whereas when the main phase alloy was not in the range, the improvement of the coercivity of the sintered blank was limited.

### Comparative Example 4

The preparation method of the permanent magnet in this comparative example was substantially the same as that in Example 1-1, except that an alloy was prepared by weighing the raw materials as shown in Table 7, that is, a blank was not prepared using a main phase alloy and an auxiliary phase alloy.

TABLE 7
Raw material table for Comparative Example 4

| | PrNd | Ce | Tb | Co | Al | Ti | Cu | Ga | Zr | B |
|---|---|---|---|---|---|---|---|---|---|---|
| Alloy component | 28 | 3.75 | 0.75 | 1 | 0.43 | 0.15 | 0.15 | 0.3 | 0.15 | 1 |

The test results of the magnetic properties of the sintered blank and the permanent magnet prepared in Comparative Example 4 are shown in Table 8.

TABLE 8
Magnetic properties in Comparative Example 4

| | Diffusion | | | |
|---|---|---|---|---|
| | material | Hcj | Br | Squareness |
| Sintered blank | | 1005 | 1.338 | 0.988 |
| Comparative Example 4 | Dy-Pr | 1221 | 1.313 | 0.941 |

The permanent magnet containing Ce was prepared by a conventional method in Comparative Example 4, that is, the raw material of Ce was added directly during smelting without using a main phase alloy and an auxiliary phase alloy to prepare a blank. As can be seen from Table 8, even if the sintered blank prepared by the conventional method was subjected to the composite diffusion treatment in the present disclosure, the improvement of the coercivity of the permanent magnet was limited.

The inventors found that due to the significant difference in the component of the composite main phase grains and the interior of the single composite main phase grain, the chemical components and the heterogeneity of the distribution cause the interior of the permanent magnet to have short-range strong exchange effect and long-range magnetostatic coupling effect, thereby effectively improving the nucleation fields of reversal magnetization domain nuclei of the permanent magnet, inhibiting the nucleation of the reversal magnetization domain nuclei, hindering the expansion of the reversal magnetization domain nuclei, and further significantly improving the coercivity of the permanent magnet.

However, when a permanent magnet is prepared by a single alloy process using Ce or Nd and a composite diffusion process, or a permanent magnet is prepared by a double alloy process using Ce and Nd and an RH diffusion process, the same performance level cannot be achieved, because the components of main phase grains are substantially equivalent and are homogeneous, and a long-range magnetostatic coupling effect cannot be formed, such that the Hcj performance equivalent to that of the present disclosure cannot be obtained under the same components and process conditions.

The exemplary embodiments of the present disclosure have been described above. However, the protection scope of the present application is not limited to the above embodiments. Any modification, equivalent, improvement, and the like made by those skilled in the art without departing from the spirit and principle of the present disclosure shall fall within the protection scope of the present disclosure.

1. An R—Fe—B permanent magnet, wherein the permanent magnet comprises at least a grain boundary and composite main phase grains;
the grain boundary comprises an RH-rich phase distributed in the form of an agglomerate within the grain boundary between the composite main phase grains, preferably at the intersection of any adjacent three or more composite main phase grains; the RH-rich phase is continuously distributed along the grain boundary in the form of a thin-layer stripe;
RH in the grain boundary has a content greater than that of the RH in the main phase grains, and the RH is at least one selected from heavy rare earth metals such as Dy, Tb, and Ho;
the composite main phase grain has a core-shell structure, wherein the core-shell structure comprises a core structure having an R-T-B type phase structure and a shell structure on the outer layer of the core structure;
the core structure comprises Ce-rich main phase grains and Ce-poor main phase grains; wherein Ce in the Ce-rich main phase grains has a content of 1-15 wt %, and Ce in the Ce-poor main phase grains has a content of 0-1 wt %.

2. The R—Fe—B permanent magnet according to claim 1, wherein the RH in the grain boundary has a content greater than that of the RH in the shell structure;
preferably, the permanent magnet comprises RL, the RL is at least one selected from light rare earth metals such as Pr and Nd;
and preferably, RL in the shell structure has a content greater than or equal to that of the RL in the core structure.

3. The R—Fe—B permanent magnet according to claim 1, wherein the R-T-B type phase structure comprises at least the following components:
R, with a weight percentage of 28%≤R≤35%, wherein the R is selected from neodymium (Nd) and cerium (Ce), and optionally comprises or does not comprise at least one selected from scandium (Sc), yttrium (Y), lanthanum (La), cerium (Ce), praseodymium (Pr), samarium (Sm), europium (Eu), gadolinium (Gd), terbium (Tb), dysprosium (Dy), holmium (Ho), erbium (Er), thulium (Tm), ytterbium (Yb), and lutetium (Lu);
B, with a weight percentage of 0.8%≤B≤1.2%;
M, with a weight percentage of 0≤M≤5%, wherein the M is at least one selected from aluminum (Al), titanium (Ti), copper (Cu), gallium (Ga), zirconium (Zr), and niobium (Nb); and
the balance of T, wherein the T consists of iron (Fe) and optionally presented cobalt (Co).

4. The R—Fe—B permanent magnet according to claim 1, wherein the permanent magnet is prepared by mixing a powder of a low-Ce master alloy and a powder of a high-Ce auxiliary alloy, press molding, sintering treatment, and then performing composite diffusion treatment;
preferably, Ce in the low-Ce master alloy has a content not greater than 1 wt %, preferably 0-1 wt %;
preferably, Ce in the high-Ce auxiliary alloy has a content greater than 1 wt % and not greater than 15 wt %;
and preferably, the permanent magnet, from the surface to the core, has phase structures of the grain boundary and the composite main phase grains.

5. A preparation method of the permanent magnet according to claim 1, wherein the preparation method comprises mixing a powder of a low-Ce master alloy and a powder of a high-Ce auxiliary alloy, press molding, and sintering treatment to obtain a blank, and performing composite diffusion treatment on the blank to obtain the permanent magnet.

6. The preparation method according to claim 5, wherein Ce in the low-Ce master alloy has a content not greater than 1 wt %, preferably 0-1 wt %;
preferably, Ce in the high-Ce auxiliary alloy has a content greater than 1 wt % and not greater than 15 wt %;
and preferably, the powder of the low-Ce master alloy and the powder of the high-Ce auxiliary alloy are in a mass ratio of (1-50):1.

7. The preparation method according to claim 5, wherein the press molding comprises mixing the powder of the low-Ce master alloy and the powder of the high-Ce auxiliary alloy, and then press molding under the action of a magnetic field to obtain a green body;
preferably, after press molding, cold isostatic pressing treatment can also be performed to further improve the density of the blank;
and preferably, the sintering treatment comprises heating the green body to 1000-1100° C. under a vacuum atmosphere to obtain a blank.

8. The preparation method according to claim 5, wherein the composite diffusion treatment comprises:
arranging a diffusion material on the surface of the blank, and performing heat treatment;
preferably, the surface of the blank is uniformly coated with a slurry containing the diffusion material;
preferably, the diffusion material comprises RH and RL optionally with or without the addition of an M powder;
preferably, the RH is at least one selected from heavy rare earth metals such as Dy, Tb, and Ho;
preferably, the RL is at least one selected from light rare earth metals such as Pr and Nd;
and preferably, the M powder is selected from Ga and/or Cu.

9. The preparation method according to claim 8, wherein the diffusion material comprises the following components: RH with a content of 20-70 wt %, RL with a content of 20-70 wt %, and an M powder with a content of 0-10 wt %;
preferably, the RH, the RL, and the M powder in the diffusion material are in a mass ratio of (1-10):(1-5):(0-2);
preferably, the RH and the RL are provided by powders of the RH and the RL, respectively;
preferably, the powder of the RH is at least one selected from a single metal of the RH, an alloy of the RH, an oxide of the RH, a fluoride of the RH, a hydride of the RH, and an oxyfluoride of the RH;
and preferably, the powder of the RL is at least one selected from a single metal of the RL, an alloy of the RL, an oxide of the RL, a fluoride of the RL, a hydride of the RL, and an oxyfluoride of the RL.

10. Use of the permanent magnet according to claim 1, wherein the permanent magnet is used for a motor.
